(19) United States
(12) Patent Application Publication
(10) Pub. No.: US 2012/0121120 A1
(43) Pub. Date: May 17, 2012

(54) NON-ENTANGLING ELECTRICAL CABLES

(76) Inventor: John Gorzelany, Glen Ridge, NJ (US)

(21) Appl. No.: 13/271,354

(22) Filed: Oct. 12, 2011

Related U.S. Application Data
(60) Provisional application No. 61/412,570, filed on Nov. 11, 2010.

(51) Int. Cl. H04R 1/00; H02G 15/02; H01B 11/00

(52) U.S. Cl. 381/384; 174/70 R; 174/74 R

(57) ABSTRACT

An electrical cable is disclosed that is tangle-free. This is achieved by having alternating lengths of firm elements with flexible lengths of cable. More specifically, the present invention provides various mechanisms for securing a length of electrical cable in a closed/folded state which can be easily opened without entanglements.

### CROSS REFERENCE TO RELATED APPLICATIONS

This application claims the benefit of U.S. Provisional Application No. 61/412,570, filed Nov. 11, 2010, and entitled “Design For Cables With Restricted Folding”, which is incorporated in its entirety herein by reference.

### BACKGROUND OF THE INVENTION

1. Field of the Invention

The present invention generally relates to a new style of cables that allows for easy folding and organization. Specifically, the present invention relates to electrical cables which are substantially tangle-free and/or tangle resistant. This self-organizing behavior is achieved by alternating lengths of firm elements with flexible lengths of cable. More specifically, the present invention provides various mechanisms for securing a length of electrical cable in a closed/folded state which can be easily opened without entanglements. By having such a cable, a user of electrical cables may easily use, stow, and re-use without having the cable entangled.

2. Description of the Related Art

Consumer electronics products typically include cables, for example, for powering a device or transfering a signal. This has led to a proliferation of cables which easily tangle. Typically, a cable (e.g. headphones for an MP3 device) is placed in a restricted space such as a pocket or purse and tangles on itself This becomes a nuisance to untangle when, for example, the headphones are retrieved. In the slightly more complicated case (e.g. a home entertainment system, or a computer system), a set of cables and their slack length may tangle together, creating both an aesthetically unappealing clutter and a detangling nuisance when the systems' connections are reconfigured.

A number of solutions have attempted to solve this type of problem, for example, spools around which the cables are wrapped, spring-powered retractors, hand crank retractors, and cable ties. Each of these attempted solutions has a concomitant problem associated therewith. For example, the spool adds significant undesired bulk. The spring-powered retractor often fails to operate on the first attempt and also adds significant undesired bulk. Hand crank retractors don't suffer the same mechanical failure as spring powered ones, but typically they are even more bulky. Cable ties are not bulky, but they require more effort to organize the cable.

There is therefore a great need in the art for a non-entangling cable that is easy to use, aesthetically pleasing, and does not take up unnecessary space. Accordingly, there is now provided with this invention an improved electrical cable effectively overcoming the aforementioned difficulties and longstanding problems inherent in cable design.

### SUMMARY OF THE INVENTION

According to one aspect of the invention, an electrical cable is disclosed comprising a plurality of hollow elongate members having the cable extended therethrough. The members are rigid relative to the cable.

According to another aspect of the invention, a headphone cable is disclosed comprising a length of cable having a jack on one end of the length and a bifurcation into two subcables at the other end of the length. A headphone is attached to each of the subcables at ends opposite from the bifurcation. A series of rigid elongate members extend along the length and the subcables. The members include attaching elements for detachably connecting the longitudinal axes of adjacent members with each other. Additional objects of the present invention will become apparent from the following description.

According to still other aspects of the invention, a cable assembly is disclosed comprising: a length of cable having a jack on one end of the length and a bifurcation into a first subcable and a second subcable at the other end of said length, at least two elongate members affixed to each of the first and second subcables, at least two elongate members affixed to the length, the elongate members having interposed between them intermediate lengths of cable. In this embodiment, the elongate members may have a first and second end, the first end positioned nearer to the jack than the second end, and the bifurcation may be located at the second end of one elongate member. Additionally, in this embodiment, the intermediate lengths of cable may have a length approximately one half the length of adjacent elongate members.

The method and apparatus of the present invention will be better understood by reference to the following detailed discussion of specific embodiments and the attached figures which illustrate and exemplify such embodiments.

### DESCRIPTION OF THE DRAWINGS

A specific embodiment of the present invention will be described with reference to the following drawings, wherein:

FIG. 1 is a headphone embodiment of the present invention in its unfolded position.

FIG. 2 is the embodiment of FIG. 1 in a folded position.

FIG. 3a is the embodiment of FIG. 2 with a wrapping device for securing all of the members of the cable together.

FIG. 3b is the embodiment of FIG. 2 with the cable itself used for securing all of the members of the cable together.

FIG. 4 is another embodiment of the present invention in a partially folded and partially unfolded position.

FIG. 5 is a headphone embodiment of the present invention in its unfolded position with one embodiment of attaching elements for detachably connecting the longitudinal axes of adjacent members with each other.

FIG. 6 is a headphone embodiment of the present invention in its unfolded position with another embodiment of attaching elements for detachably connecting the longitudinal axes of adjacent members with each other.

FIG. 7 depicts various embodiments of attaching elements.

### DESCRIPTION OF THE PREFERRED EMBODIMENT

The following preferred embodiment as exemplified by the drawings is illustrative of the invention and is not intended to limit the invention as encompassed by the claims of this application.

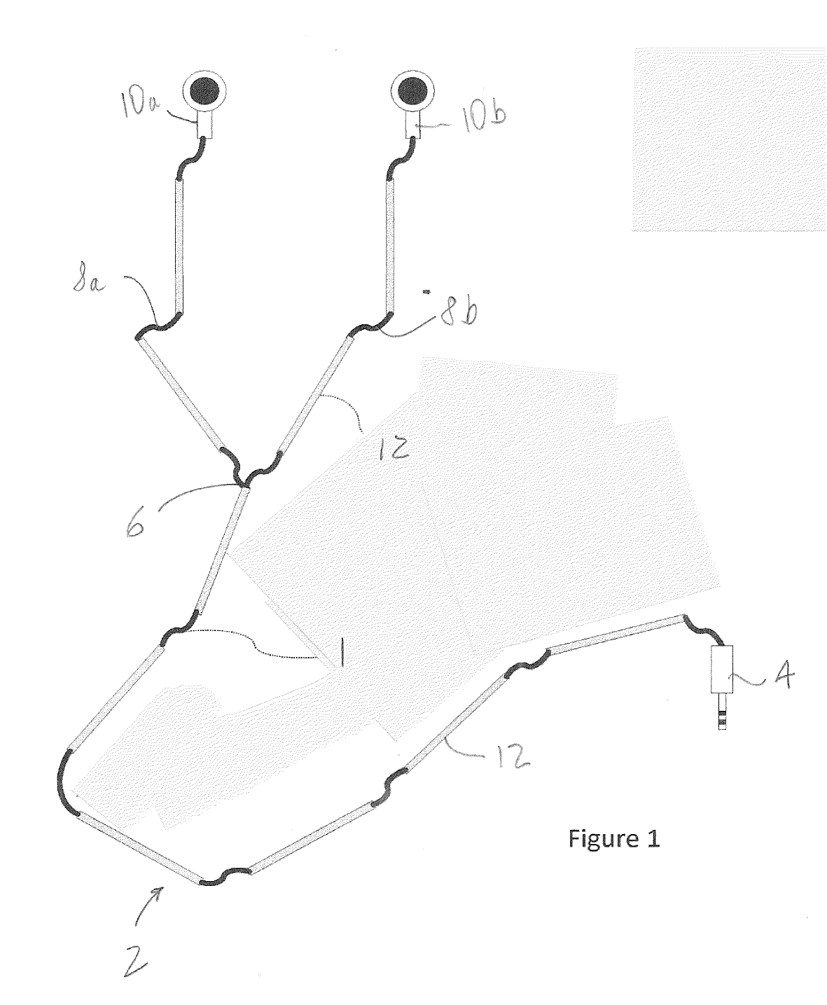

The electrical cable of the present invention is illustrated generally in FIGS. 1-6. In FIG. 1, an electrical cable 1 of the present invention is illustrated in the embodiment of a unfolded conventional earbud headphone. The electrical cable 1 is typically flexible and extends in a length 2 from a jack 4 on one end of the length 2 and a bifurcation 6 on the other end of the length 2. The bifurcation 6 splits into two subcables 8a and 8b, respectively. Headphones 10a and 10b are attached to each of the subcables 8a and 8b at ends opposite from the bifurcation 6. A series of members 12 extend along the length 2 and the subcables 8a and 8b.

The members 12 are preferably rigid and hollow elongate members which are only rigid relative to the flexible electrical cable 1. All of the elongate members are preferably substantially the same length, however, such length may range from about one or two inches to a couple of feet depending on the absolute length of the cable itself. The elongate members 12 may slide along the length of the cable or may be affixed directly to the cable. In this way, the members create alternating relatively rigid and relatively flexible lengths. Typically, the relatively rigid members are a longer length than the relatively flexible lengths.

In one embodiment of the present invention, the rigid hollow elongate members are formed on the cable during the manufacturing process. In another embodiment of the present invention, the rigid hollow elongate members may be formed with a longitudinal slit extending the full length of each member so that they may be placed on the cable after the cable has been manufactured, for example, by a consumer. In both of these instances, however, the elongate members may either slide along the length of the cable or may be affixed directly to the cable.

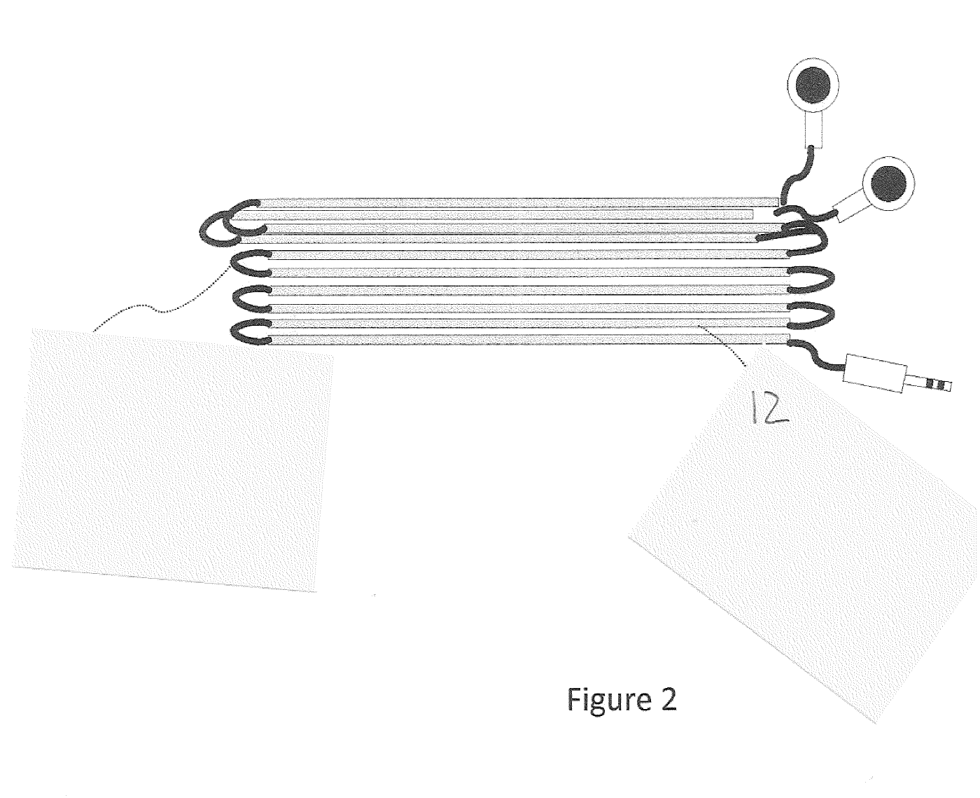

FIG. 2 illustrates the embodiment of FIG. 1 in a folded position for storage. As shown, the elongate members 12 are configured so that the longitudinal axes of adjacent members are aligned with each other.

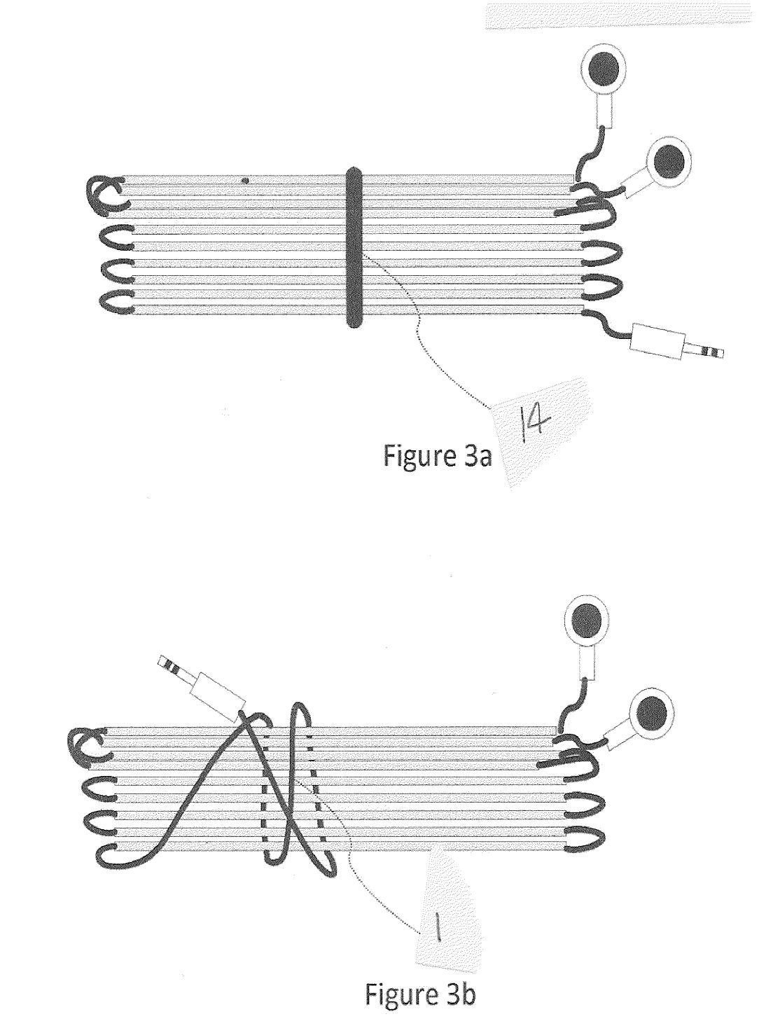

FIGS. 3a and 3b show the embodiment of FIG. 2 with all of the members of the cable secured together. In the case of FIG. 3a, the elongate members are secured with a wrapping device 14, for example, an elastic band, a cable tie, a cord, or a length of fabric. In the case of FIG. 3b, the elongate members are secured with a length of the cable itself

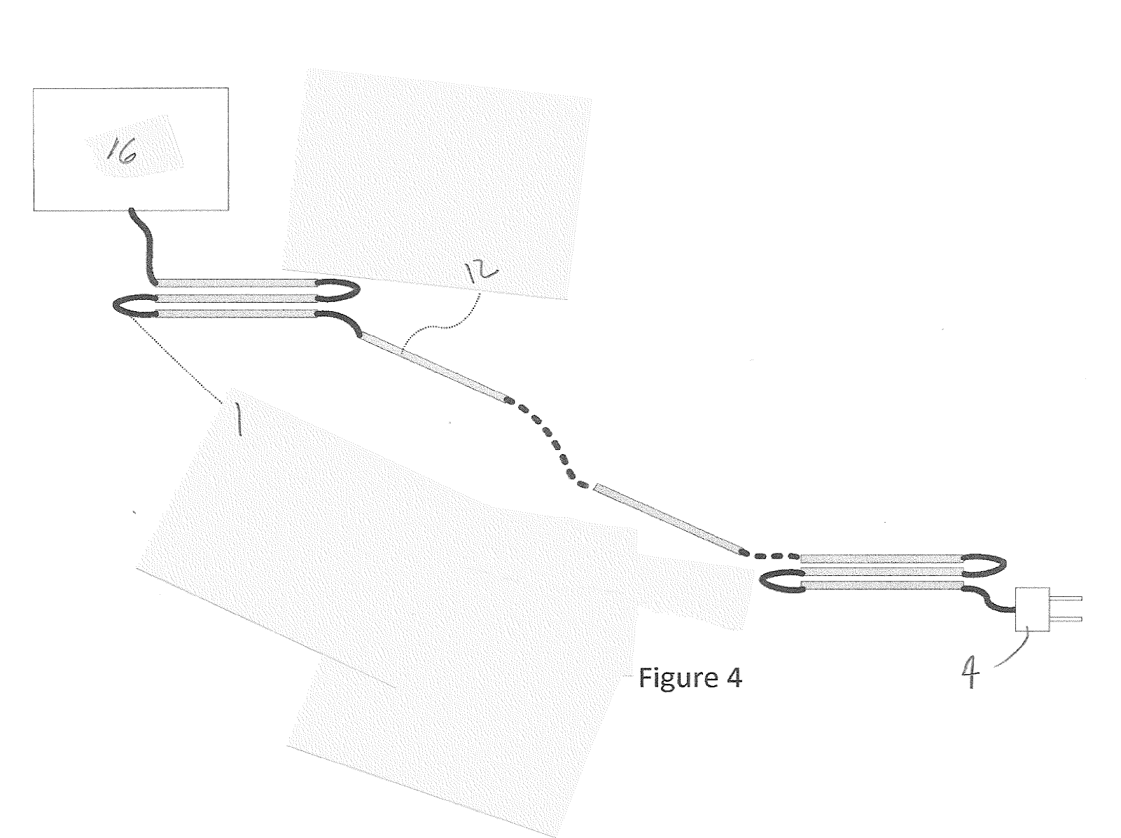

FIG. 4 shows another embodiment of the present invention. In this embodiment, the electrical cable 1 extends from the jack 4 (in this case an electrical plug) to an electronic device 16. As this configuration may be a great length (several feet) it may be advantageous to have the cable placed in a partially folded position and in a partially unfolded position. As illustrated therein, the partially folded position may be both closest to the device and the jack and the partially unfolded position may be therebetween. Of course, any combination of folded and unfolded positions may be used for creating an aesthetically pleasing configuration and/or for organizing and protecting the cables.

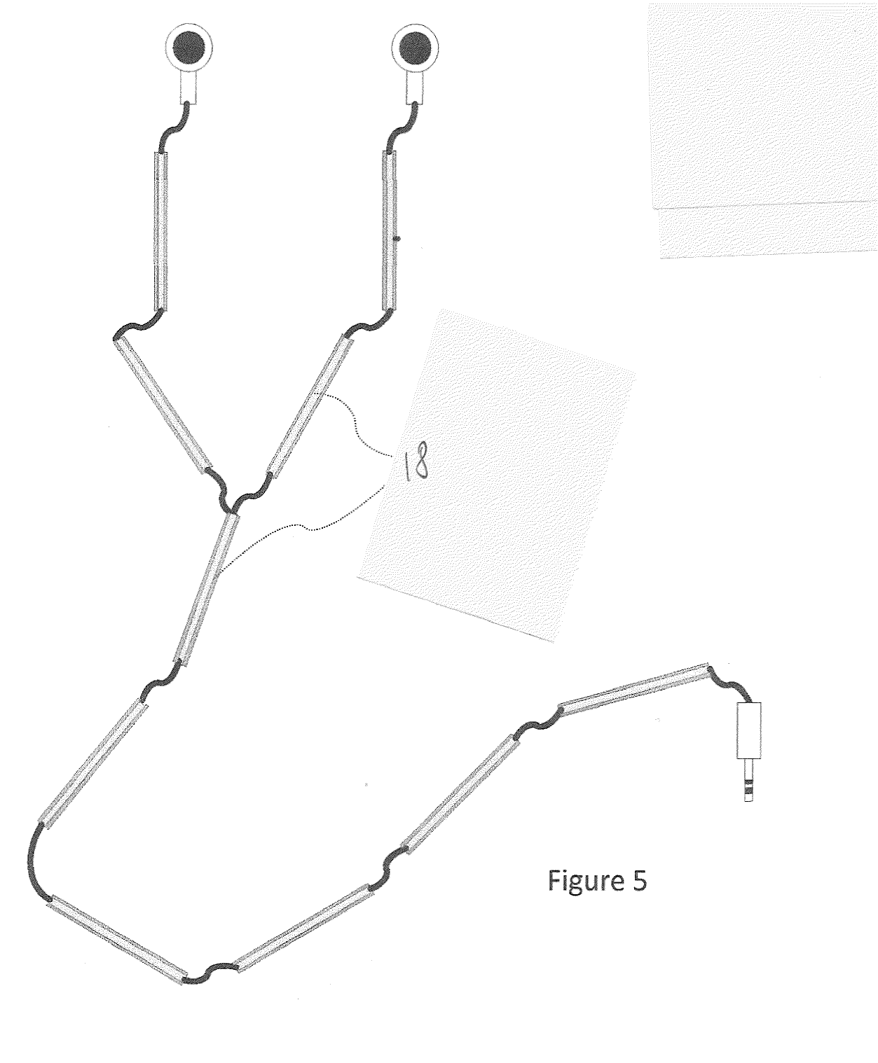

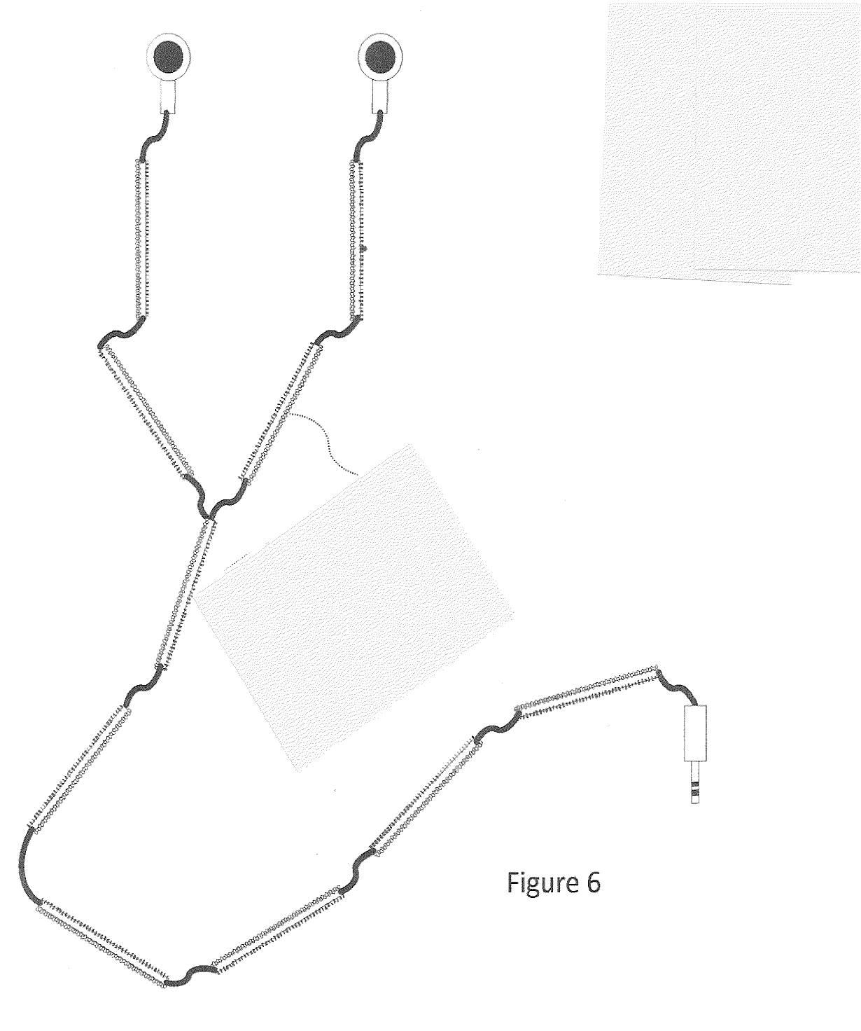

FIGS. 5 and 6 are headphone embodiments of the present invention in its unfolded position illustrating one embodiment of the attaching elements 18 of the elongate members for detachably connecting the longitudinal axes of adjacent members with each other. The attaching elements shown in FIG. 5 are complimentary mechanical elements. Such complimentary mechanical elements may be for example, magnets, detents, tongue in groove, peg in hole, snaps, intermeshed springs, or any other type of male and female elements well known to those skilled in the art.

As more specifically shown in FIG. 6, the attaching elements 18 may be fabricated of hook and loop elements for detachably connecting the adjacent members with each other.

As an additional enhancement, the flexible sections can be fabricated in such a way as to have a tendency to return to the closed state on their own (e.g. made with springs). This enhances the self-organizing property of the invention. For example, springs or preformed curved sections may be formed of semi-rigid plastic. Alternatively, the flexible lengths may comprise a material that mimics human muscle or one that contracts and expands in response to the application of an electrical current.

A further alternative may include the replacement of some or all of the relatively rigid lengths with semi-rigid lengths that retain a shape after force is applied, for example, twist-ties or pipe cleaners. A still further alternative may include the replacement of some or all of the relatively rigid lengths with semi-rigid lengths that “remember” their previous orientation that automatically flip between two remembered orientations.

The preferred embodiment exhibits a plurality of alternating lengths of firm and flexible cable. The cables can be made from but are not limited to plastic coated wire and electronic fiber. The rigid sections are significantly stiffer than the flexible sections and can be made from, but are not limited to: plastic, wood, metal, fiberglass, carbon fiber, and clay.

Preferred embodiments may include attaching elements for detachably connecting the longitudinal axes of adjacent members with each other. Items 108-111 comprise single attaching means structures which, when affixed radially from a longitudinal element 12 (shown in FIG. 1, e.g.), one or more attaching means from one element 12 may mate with one or more corresponding attaching elements from another element 12, thereby hooking to one another to effect attachment of one element 12 to the other. Element 112 comprises an elongated attaching means which would be affixed to elements 12 and operate in the same manner as previously described for the single attaching elements.

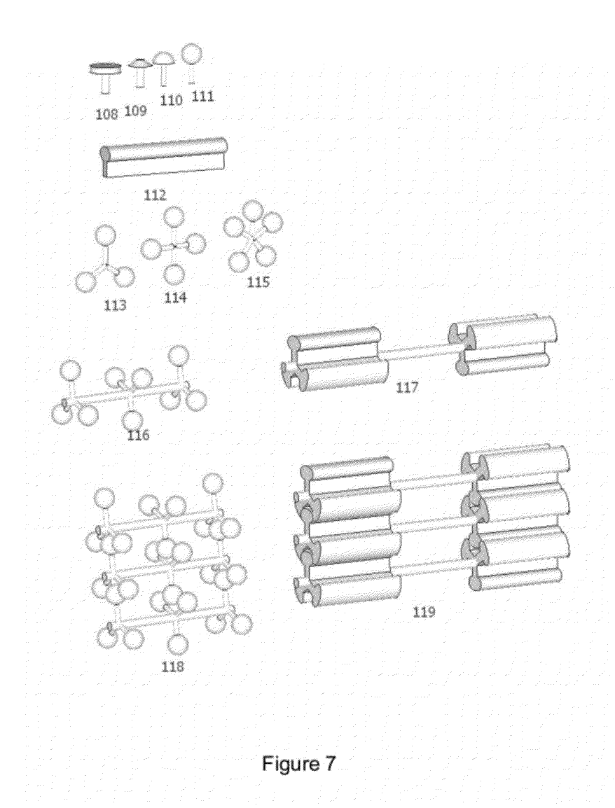

Items 113-115 of FIG. 7 depict more complicated attaching means which may be affixed to elements 12 as shown in item 115 and may mate with other such attaching elements on other elements 12 as shown in item 118. Likewise, extruded versions of items 113-116 may be attached to elements 12 as shown in item 117 and mated with other such attaching elements on other elements 12 as shown in item 119.

Although the particular embodiments shown and described above will prove to be useful in many applications in the electrical cable arts to which the present invention pertains, further modifications of the present invention will occur to persons skilled in the art. All such modifications are deemed to be within the scope and spirit of the present invention as defined by the appended claims.

What is claimed is:

1. An electrical cable comprising a plurality of hollow elongate members having the cable extended therethrough, wherein said members are rigid relative to said cable.

2. The cable of claim 1, wherein said members include attaching elements for detachably connecting the longitudinal axes of adjacent members with each other.

3. The cable of claim 2, wherein said elements of adjacent members are complementary.

4. The cable of claim 3, wherein said elements comprise hook and loop attachments.

5. The cable of claim 3, wherein said elements comprise magnets.

6. The cable of claim 3, further comprising a wrapping device for securing all of said members together.

7. The cable of claim 3, wherein said elements each comprise a slit extending the length thereof for inserting the cable therethrough.

8. A headphone, comprising:
a. a length of cable having a jack on one end of said length and a bifurcation into two subcables at the other end of said length;
b. a headphone attached to each of said subcables at ends opposite from said bifurcation; and
c. a series of rigid elongate members extending along said length and said subcables,
wherein, said members include attaching elements for detachably connecting the longitudinal axes of adjacent members with each other.

9. The headphone of claim 8, further comprising a wrapping device for securing all of said members together.

10. The headphone of claim 8, wherein said elements each comprise a slit extending the length thereof for inserting the cable therethrough.

11. A cable assembly comprising:
a. a length of cable having a jack on one end of said length and a bifurcation into a first subcable and a second subcable at the other end of said length;
b. at least two elongate members affixed to each of said first and second subcables;
c. at least two elongate members affixed to said length;
said elongate members having interposed between them intermediate lengths of cable.

12. The cable assembly of claim 11 where in each of said elongate members has a first and second end, the first end positioned nearer to the jack than the second end.

13. The cable assembly of claim 12 wherein said bifurcation is located at the second end of one elongate member.

14. The cable assembly of claim 11 wherein said intermediate lengths of cable have a length approximately one half the length of adjacent elongate members.

15. The cable assembly of claim 13 wherein said intermediate lengths of cable have a length approximately one half the length of adjacent elongate members.

16. The cable of claim 11, wherein said members include attaching elements for detachably connecting the longitudinal axes of adjacent members with each other.

17. The cable of claim 16, wherein said elements of adjacent members are complementary.

18. The cable of claim 17, wherein said elements comprise hook and loop attachments.

19. The cable of claim 17, wherein said elements comprise magnets.

20. The cable of claim 17, further comprising a wrapping device for securing all of said members together.
